(19) United States
(12) Patent Application Publication
(10) Pub. No.: US 2002/0134899 A1
(43) Pub. Date: Sep. 26, 2002

(54) Parts holders

(76) Inventor: Andrew L. Stickney, Woodbury, MN (US)

Correspondence Address: Carl L. Johnson, Jacobson and Johnson, Suite 285, One West Water Street, St. Paul, MN, 55107-2080, US

(21) Appl. No.: 09/814,592

(22) Filed: Mar. 22, 2001

(51) Int. Cl. F16M 11/00

(52) U.S. Cl. 248/176.1

(57) ABSTRACT

A quick release part holder comprising a housing having a part receiving opening therein and at least one finger mounted to said housing with the finger having a part engaging surface. The finger is positionable in either a part engaging position or a part releasing position with the part engaging surface movable from the part engaging position to the part releasing position by displacement of the finger.

### FIELD OF THE INVENTION

This invention relates generally to parts holders and more particularly to a parts holder for temporarily holding parts while a task is performed on the parts and quickly releasing parts after the task is completed.

### BACKGROUND OF THE INVENTION

The concept of parts holder is known in the art, generally parts holders comprises some type of device for temporarily holding a part during a task. In some cases the task involves applying a finish or a coating to a part or in other cases the task may involve actual work in shaping the part. One finishing application is in the plating industry where a number of parts are mounted on a rail and then subject to a plating process. When the plating is completed, the parts are removed from the rail and a new set of parts are positioned on the rail and the process of plating the parts is repeated Other uses of parts holder can be to hold a part while machining is performed on the part and in still other applications the part holder can be used to hold a plurality of parts for viewing. In each case once the task is completed the part is released from the parts holder so the parts holder can be reused.

The present invention provides a parts holder that can be used to temporarily hold parts for various tasks including viewing, working or finishing the part and once the task is completed the parts can be quickly released from the parts holder so that a new batch of parts can be temporarily secured to the parts holder.

### SUMMARY OF THE INVENTION

A quick release part holder comprising a housing having a part receiving opening therein and at least one finger cantileverly mounted to the housing with the finger having a part engaging surface. The finger is normally maintained in a part engaging position which frictionally holds the part in the parts holder but the finger can be positionable in either a part engaging position or a part releasing position. The finger is movable from the part engaging position to the part releasing position by cantileverly flexing of the finger. If a plurality of fingers are used, a release rod can be inserted into the housing to displace each of the plurality of fingers to release a part held therein.

### BRIEF DESCRIPTION OF THE DRAWINGS

FIG. 1 is a front view of the parts holder mounted in a support rail.

FIG. 2 is an end view of the parts holder and support rail of FIG. 1.

FIG. 3 is a partial sectional top view of the parts holder and support rail of FIG. 1.

FIG. 4 is an isolated view of the support rails and a pair of side-by-side resilient fingers.

FIG. 5 is an end view of the parts holder illustrating the resilient fingers in the part engaging position (solid lines) and the parts release position (dotted lines).

FIG. 6 is a partial front view of a release rod for moving the resilient fingers from the parts engaging position to the parts releasing position.

FIG. 7 is a top view illustrating the part end of the resilient finger in the part engaging position.

FIG. 8 is a top view illustrating the part end of the resilient finger in a part releasing position.

### DESCRIPTION OF THE PREFERRED EMBODIMENT

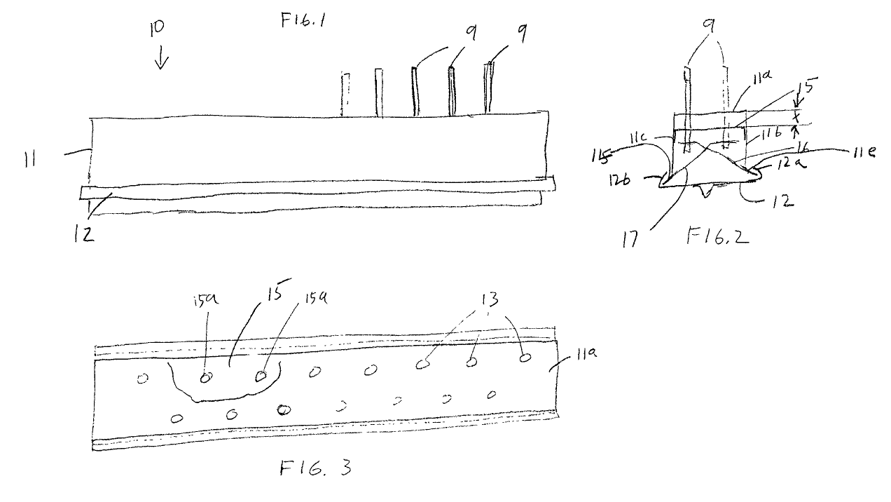

FIG. 1 is a front view of a parts holder 10 mounted in an elongated support member 12. Parts holder 10 includes a housing 11 having a set of parts 9 which are temporarily held in parts holder 10 so that a task can be performed to the parts 9.

FIG. 2 is an end view of the parts holder 10 and support member 12 with the support member 12 having elongated ears 12a and 12b extending along support member for slidingly engaging the lower ends of housing 11. Ears 12a and 12b prevent upward withdrawal of housing 11 from support member 12 while the parallel positioning of ears 12b and 12a with respect to the lower ends 11e and 11f allows housing 11 to be slid free of support member 12. This feature allows support member 12 to be permanently mounted to a fixture and the parts holder housing 11 to be quickly attached or detached from the support member to enable the parts therein to be removed.

Housing 11 has a general U-shape with a top rail 11a and a lower rail 15 which is mounted to housing 11 by spot welding or the like. In the preferred embodiment top rail 11a is formed by metal stamping as is lower rail 15 which is located in a spaced condition from top rail 11a, as indicated by x. In the condition shown the rails 11a and 15 are parallel to each other with the openings in rail 11a being in alignment with the openings in rail 15. The sidewalls of the openings in rail 11a and rail 15 provide a two position fixed support for positioning parts in a preferred orientation as the parts have a slightly smaller diameter than the openings to allow for ease in insertion or removal of parts. Although two rails are shown it is envisioned that only one rail of sufficient thickness could be used to provide the two position fixed support for maintaining parts in a preferred orientation. However, by using a separate rail 15 that can be attached to housing 11 it allows one to fabricate the parts holder 10 from sheet metal by a process of metal stamping thus reducing cost. On the other hand if desired one could form a thicker single rail having openings extending therethrough to provide guide surfaces for a part Located between lower rail 15 is a first resilient finger 15 and a second resilient finger 17 which coact with the rails 11a and 15 to provide the frictional resistance to removal of a part from the parts holder 10.

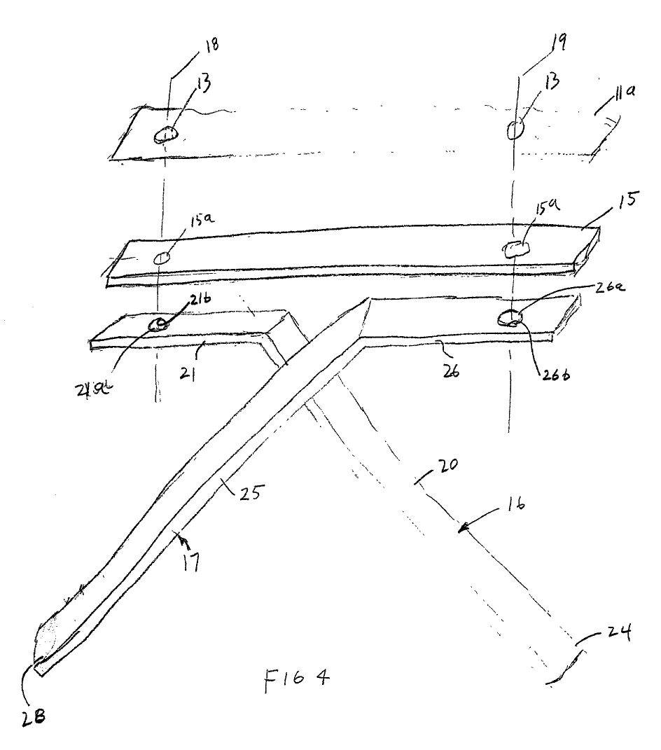

FIG. 3 is a top view of the parts holder 10 and support rail 11a showing a set of holes 13 located in a staggered position on top rail 11a. A similar set of holes 15a are located in lower rail 15 as illustrated by the cut away section in FIG. 3.

FIG. 4 is a partial sectional view of the components of parts holder 10 which are shown in isolated and exploded detail. The parts holder 10 includes resilient fingers 16 and 17 that are located in a side-by-side position. While only two resilient fingers are shown for a part holder to hold a plurality of parts a resilient finger having a part engaging end would be aligned with each of the set of holes 13 and 15a. That is, a first row of resilient fingers can be mounted to one side of housing 11 and a second row of resilient fingers can mounted to the opposite side of housing 11 with the resilient fingers positioned in side-by-side position in housing 11.

Resilient finger 16 has a mounting end 24, an intermediate section 20 and a part engaging end 21 angularly offset from intermediate section 20 with the part engaging end operable for frictionally engaging a part. Similarly, resilient finger 17 has a mounting end 28, an intermediate section 25 and a part engaging end 26 angularly offset from intermediate section 25 for frictionally engaging a part.

The top rail 11 is shown spaced from lower rail 15 with top rail 11a having a set of openings 13 and lower rail 15 having a set of openings 15a. The set of openings 13 and set of openings 15a are maintained in a fixed orientation. Located below lower rail 15 is a part engaging end 21 having an opening 21a and similarly located between lower rail 15 is part engaging end 26 having an opening 26a. In the view shown in FIG. 4 the resilient fingers 16 and 17 are in the part release position. In the part release position, a first central axis 18 extends through the center of each of openings 13, 15a and 21a which are located on the left side of the Figure. Similarly, a second central axis 19 extends through the center of each of openings 13, 15a and 26a which are located on the right side of FIG. 4.

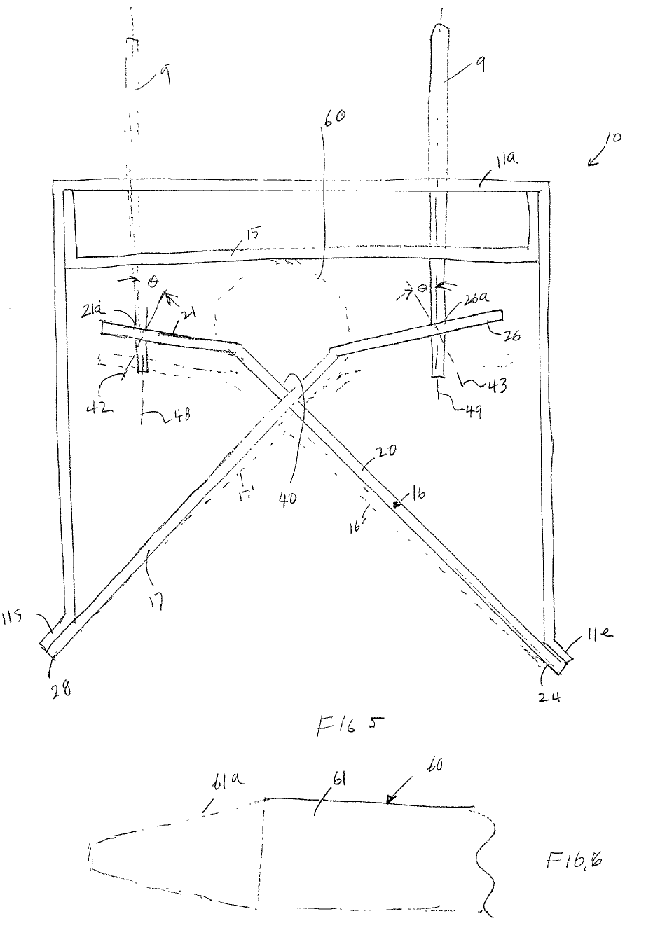

In order to appreciate the operation of the parts holder 10 reference should be made to FIG. 5, which is an end view of the parts holder 100, illustrating the resilient finger 16 in the part engaging position (as indicated by solid lines 16) and the parts release position (as indicated by dotted lines 16′) and the resilient finger 17 in the part engaging position (as indicated by solid lines 17) and the parts release position (as indicated by dotted lines 17′).

The end 24 of resilient finger 16 is shown cantileverly attached to elongated edge 11e of housing 11 by a process such as spot welding or the like. Resilient finger 16 extends upward into a cavity of housing 11 with a part 9 extending through the part engaging end 21, which has an opening 21a therein. A central axis 42, which is generally normal to part engaging end 21, extends through opening 21a in part engaging end 21. The central axis 42 is shown in misalignment with a central axis 48 extending longitudinally through part 9 as indicated by the angle ø. Similarly, end 24 of resilient finger 17 is shown cantileverly attached to elongated edge 11f of housing 11 by a process such as spot welding or the like.

Resilient finger 17 extends angularly upward into the cavity of housing 11 and across resilient finger 16 forming a V-shaped region identified by reference numeral 40. Finger 17 has part engaging end 26 with an opening 26a extending through the part engaging end with a central axis 43 which extends in a direction normal to part engaging end 26. The central axis 43 is shown in misalignment with a central axis 49 extending longitudinally through part 9 as indicated by the angle ø. This misalignment of the axis produces frictional resistance to displacement of parts 9 along their respective axis. That is, in the part engaging position (shown by the solid lines of FIG. 5) the sidewall 21b (see FIG. 4) of part engaging end 21 and the sidewall 26b (see FIG. 4) of part engaging end 26 engage the sides of part 9 to hold the part in position.

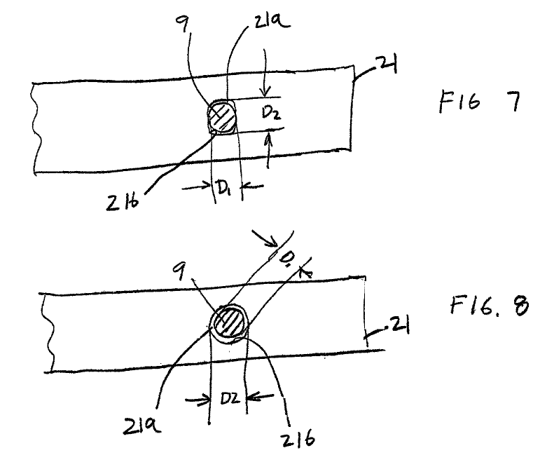

To illustrate the frictional and non frictional engagement of part 9 with a part engaging end 21 reference should be made to FIG. 7 which shows an isolated top view of part 9 and part engaging end 21 in a part engaging position (frictional engagement) while FIG. 8 shows an isolated top view of part 9 and part engaging end 21 in the part release position (non frictional engagement).

FIG. 8 shows part engaging end 21 has a diameter D₂ while the part has an opening of diameter D₁ with D₂ larger than D₁. The diametrical difference is such that part 9 can be freely extended through hole 21a. In the condition shown in FIG. 8 the part engaging end 21 is in the position indicated by dotted lines in FIG. 5. In this condition the part 9 is not frictionally restrained by the sidewall 21b of opening 21a. With part engaging end 21 in the position shown with respect to part 9 the part 9 is held in axial alignment with axis 48 which allows for removal from parts holder 10 or insertion of parts 9 into parts holder 10.

Referring to FIG. 7, which shows the part engaging end 21 in the part engaging position, one notes part engaging end 21 has now been pivoted upward about mounting end 24 so that a view looking along part 9 shows that the opening 21 appears oblong with opposite circumferential faces of sidewall 21b engaging the outer surface of part 9 to frictionally hold the part 9 in position. That is, with all three openings in alignment the part 9 can be extended through all three openings but with one of the parts carrying an opening 21b tilted at an angle with respect to the part 9 the sidewalls of opening 21b bind against the outer surface of part 9 to frictionally hold part 9 in position while the sidewalls of the openings in rails 11 and 15a coact with the finger to provide for securement of parts therein.

In the position shown in FIG. 4 the parts 9 are positioned in the openings of rail 11a and 15a. The outer diameter of part 9 is slightly smaller than the openings in rails 11a and 15a to enable the parts to be inserted into the openings in the two rails. The Opening 26a in part engaging end 26 and opening 21a in part engaging end 21 are also larger than the diameter of part 9. However, if the part engaging end 26 is tilted with respect to the central axis it presents an oblong shaped passage to the part. That is the resilient fingers which exhibit an upward bias flex upward to cause the part engaging end to frictionally hold the part 9 in position.

One of the features of the present invention is the quick release of the parts held in the part holder 10. FIG. 5 shows a portion of an elongated release rod 60 having a cylindrical section 61 with a tapered end 61a.

Referring to FIG. 5 the release rod 60 is shown in dotted lines with one portion of release rod contacting the under side of rail 15 and the other portion engaging the resilient fingers 16′ and 17′ at the cross junction 40 between the two resilient fingers. That is, release rod 60 has been inserted underneath housing rail 15 by inserting end 61a into the space between fingers 16 and 17 (shown in solid lines) and the underside of rail 15. Continued extension of release rod 60 forces the resilient members 16 and 17 into the part release position as indicated by dashed lines 16 and 17. Consequently, by extending release rod along the under side of rail 15 one can bend each of the side-by-side fingers downward into a condition where the openings in the part engaging end are in axial alignment with the parts 9 thus disengaging the sidewalls of the part engaging ends form the parts allowing the parts 9 to be quickly removed from the part holder. In practice the part holder can be turned upside down and the parts 9 allowed to fall into a bin as the task is completed.

As can be seen in FIG. 5 a feature of my invention is the positioning of the row of resilient fingers 16 and 17 and rails 11a and 15 to form an open end parts holder which allows one to clean the parts holder 10 by flushing any foreign material out of the parts holder by directing water or the like endwise through the parts holder.

I claim:

1. A quick release parts holder comprising:
a housing, said housing having a first opening therein with the first opening having a sidewall and a first central axis;
a rail, said rail attached to said housing, said rail having a second opening therein with the second opening having a sidewall and a second central axis, with said first central axis and said second central axis being in axial alignment with each other;
a resilient finger, said resilient finger having a mounting end for cantilever securement to said housing and a part engaging end, said part engaging end having a third opening having a sidewall therein with said third opening having a third central axis, said part engaging end positionable in a part engaging position so that said third central axis of said part engaging end is in misalignment with the first central axis and said second central axis to thereby enable the sidewall of the said third opening to frictionally engage and hold a part located in said first opening and said second opening, said part engaging end positionable in a part releasing position to enable said third central axis to be brought into axial alignment with said first central axis and said second central axis to thereby release the part.

2. The quick release part holder of claim 1 including a release rod, said release rod positionable proximate said resilient finger to resiliently bend said resilient finger to thereby move said part engaging end from a part engaging position to a part releasing position or vice versa.

3. The quick release part holder of claim 1 wherein the quick release parts holder comprises stamped sheet metal.

4. The quick release part holder of claim 1 wherein the resilient finger part engaging end is in the part engaging position and the part engaging end is located in a non-parallel condition to the said housing and said rail.

5. The quick release part holder of claim 1 including at least two rows of resilient fingers with each of the rows of resilient fingers interleaving positioned in a side-by-side condition.

6. The quick release part holder of claim 1 wherein the resilient finger comprises metal.

7. The quick release part holder of claim 1 wherein the part engaging end of the resilient finger is angularly offset with respect to an axis through said resilient finger.

8. A quick release part holder comprising:
a housing, said housing having a part receiving opening therein;
a finger, said finger mounted to said housing with said finger having a part engaging surface, said finger positionable in either a part engaging position or a part releasing position with the part engaging surface movable fiom the part engaging position to the part releasing position by displacement of said finger.

9. The quick release part holder of claim 9 wherein the finger is part of a first set of fingers with each of the first set of fingers positioned proximate a second set of fingers to enable each of the fingers to simultaneously hold a part therein.

10. A quick release part holder comprising:
a housing, said housing having a part receiving opening therein;
a resilient finger, said resilient finger cantileverly mounted to said housing with said resilient finger having a part engaging end positionable in either frictional part engagement or non-frictional part engagement with the part engaging end movable from the frictional part engagement position to non-frictional part engagement by flexing said resilient finger.

11. The quick release part holder of claim 10 including a plurality of resilient fingers.

12. The quick release part holder of claim 10 wherein the part receiving opening comprises two parallel spaced members each having part receiving openings therein..

13. The quick release part holder of claim 10 wherein the part engaging end includes an opening having a sidewall therein for forming frictional part engagement.

14. The quick release part holder of claim 13 wherein the opening in the part engaging end comprises a hole having a diameter larger than the diameter of a part to be held therein.

15. The quick release part holder of claim 10 including at least two resilient fingers with one of the resilient fingers diagonally positioned with respect to the other so that a force applied to a diagonal junction of the at least two resilient fingers simultaneously moves the resilient fingers from a part engaging position to a part releasing position or vice versa.

16. The quick release part holder of claim 10 wherein the housing includes a first side rail and a second side rail.

17. The quick release part holder of claim 16 including a fixture having a set of lips for sliding capturing the first side rail and the second side rail.

18. The quick release part holder of claim 10 wherein the openings are circular.

19. The quick release part holder of claim 10 wherein the resilient fingers and the housing are stamped from sheet metal.

20. The quick release part holder of claim 11 including a release rod, said release rod having a tapered end so that when said release rod is laterally slid in said housing said release rod deflects said resilient fingers to move said resilient fingers from a part engaging position to a part releasing position.
